(19) United States
(12) Patent Application Publication
(10) Pub. No.: US 2006/0026329 A1
(43) Pub. Date: Feb. 2, 2006

(54) System and method for an arbiter rewind

(76) Inventor: James Kon Yu, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/903,401

(22) Filed: Jul. 30, 2004

(51) Int. Cl. G06F 13/36

(52) U.S. Cl. 710/309

(57) ABSTRACT

The rewind arbiter system provides a system and method for arbitrating a device. Briefly described, one embodiment comprises a plurality of controlled devices configured to access a shared component and a rewind arbiter configured to arbitrate among a plurality of requests received from the controlled devices, wherein one of the controlled devices communicating a request that is selected during arbitration is then granted access to the shared component. The rewind arbiter further comprising; an arbitration scheme configured to grant arbitrated requests to the controlled devices, a verification scheme configured to verify that the controlled device successfully completes communication with the shared component, and a rewind scheme configured to cause the arbitration scheme to rewind back to the controlled device that has failed to successfully complete communication with the shared component such that the failed control device is granted a second arbitrated request.

### TECHNICAL FIELD

Embodiments generally related to arbiters and, more particularly, is related to a system and method for overcoming device starvation in an arbiter.

### BACKGROUND

Computer architecture commonly employs a plurality of devices that share common components. Access to common components by the devices must be regulated such that only a single device is accessing (using) a shared component at any given time. That is, the shared component is busy serving only the device having current access to it. If other devices need to also access the shared component, they must wait until the device currently accessing the shared component is finished. Then, the next device accesses the shared component.

When only two devices are using a shared component, the wait time for the component desiring access of the busy shared component may be of sufficiently short duration that overall system performance is not significantly degraded. If more that two devices are using the shared component, then schemes are typically employed to provide ordered access to waiting devices.

An arbiter may be used to control the devices competing for access to a shared component. Arbiters may enable access of a plurality of devices to the shared component based on device priority or device queuing. One example of device queuing is the “round robin” scheme whereby devices simply wait for their turn to access the shared component based upon some predefined ordering of the devices. Another example is queuing by random device selection performed by the arbiter. With random arbitration, access to the shared component, when it becomes available, is based on a random selection among devices that need access to the shared component. Composite schemes may also be employed, such as when a priority scheme is combined with a round-robin scheme or a random selection scheme.

Complexity of an arbitration scheme increases as the number of devices increases. That is, if only two devices share the common component, the arbiter has a simple job of allocating access to the two devices (if an arbiter is even required). If three devices share the common component, the arbiter still has a relative simple job of allocating access to the three devices. However, if many devices share the common component, the arbiter may have a very complex job of allocating access to the many competing devices.

In various situations, it may happen that a device needing access to a shared component may be repeatedly denied access to the shared component by the arbiter. For example, in a priority arbitration system, the device may have a relatively low priority compared to other competing devices. If the higher-priority devices are continuously accessing the shared component, the lower-priority device is denied access by the arbiter.

This access denial of a device to a shared component is commonly referred to as “starvation” of the device. If one or more devices are denied access (“starved”) for a relatively long period of time, system performance may be degraded to an unacceptable level, particularly if the starved device needs to perform a critical function. In extreme situations, system operation may even be halted.

### SUMMARY

The rewind arbiter system provides a system and method for arbitrating a device. Briefly described, one embodiment employs a plurality of controlled devices configured to access a shared component and a rewind arbiter configured to arbitrate among a plurality of requests received from the controlled devices, wherein one of the controlled devices communicating a request that is selected during arbitration is then granted access to the shared component. The rewind arbiter further comprising; an arbitration scheme configured to grant arbitrated requests to the controlled devices, a verification scheme configured to verify that the controlled device successfully completes communication with the shared component, and a rewind scheme configured to cause the arbitration scheme to rewind back to the controlled device that has failed to successfully complete communication with the shared component such that the failed control device is granted a second arbitrated request.

Another embodiment is a method for arbitrating a plurality of requests from a plurality of controlled devices competing for access for communication to a shared component to which the plurality of controlled devices are coupled to; granting an arbitrated request to a selected first one of the plurality of controlled devices as determined by the arbitrating, and wherein upon granting, the first controlled device may begin its communication with the shared component; verifying that the first controlled device has successfully completed communication with the shared component; rewinding back to the first controlled device when the verifying indicates that the first controlled device has failed to successfully complete communication with the shared component; and granting a second arbitrated request to the first controlled device.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating a rewind arbiter system employing an embodiment of a rewind arbiter.

FIG. 2 is a block diagram illustrating operation of an embodiment of a rewind arbiter operating when starvation of a controlled device is not occurring.

FIGS. 3A-C are block diagrams illustrating operation of an embodiment of a rewind arbiter operating when starvation of a controlled device is occurring.

FIG. 4 is a flowchart illustrating an embodiment of a process for arbitrating device access.

FIG. 5 is a block diagram illustrating another rewind arbiter system employing an embodiment of a rewind arbiter.

### DETAILED DESCRIPTION

Embodiments of a rewind arbiter provide a system and method for detecting starvation of a device controlled by an arbiter. After the rewind arbiter receives a request from a controlled device, the rewind arbiter arbitrates the request from that device among a plurality of competing controlled devices. During arbitration, the request from one of the competing controlled devices is selected using an arbitration process, and the request is communicated to the downstream device. For convenience, the request that is communicated to the downstream device is referred to herein as the “arbitrated request” since is communicated from the rewind arbiter. The rewind arbiter then determines if the communicated request was successfully completed by the controlled device. If not, the rewind arbiter “rewinds” back to that controlled device and grants another arbitrated request for that controlled device. Again, the rewind arbiter determines if the subsequent request was successfully completed by the controlled device. If not, in one embodiment, the rewind arbiter repeatedly grants arbitrated requests for the controlled device until the request is successfully completed by the controlled device.

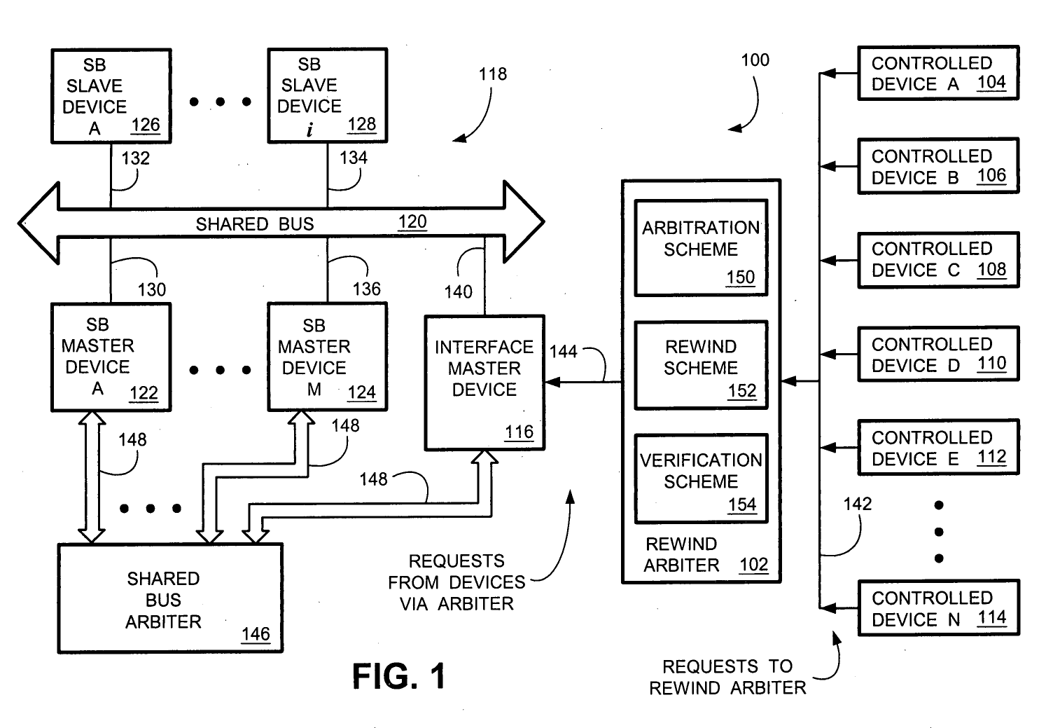

FIG. 1 is a block diagram illustrating a rewind arbiter system 100 employing an embodiment of a rewind arbiter 102. The rewind arbiter system 100 is intended to illustrate an exemplary system employing a rewind arbiter 102. Accordingly, the rewind arbiter 102 can be implemented in a variety of systems such that the rewind arbiter 102 controls a plurality of devices competing for access to a commonly shared device or component. Access is controlled by the rewind arbiter 102 by selecting, from among competing requests from the controlled devices, one of the requests. That is, the selected request has been arbitrated and the “arbitrated request” is then communicated downstream from the rewind arbiter 102 to the commonly shared device or component.

In the exemplary system, access of a plurality of controlled devices (device A 104, device B 106, device C 108, device D 110, device E 112, through device N 114) to the interface master device 116 is controlled by the rewind arbiter 102. A request is communicated to the rewind arbiter 102 from one of the controlled devices, via path 142. The request indicates to the rewind arbiter 102 that the controlled device needs access to the interface master device 116. The rewind arbiter 102 communicates an arbitrated request to the interface master device 116. Accordingly, the selected controlled device, when it is its turn, has access to the shared bus system 118 via the interface master device 116 (when the interface master device 116 has access to the shared bus 120).

The exemplary shared bus system 118 comprises a shared bus 120 to which a plurality of shared bus (SB) “master” devices (SB master device A 122 through SB master device M 124) and a plurality of shared bus (SB) “slave” devices are coupled to (SB slave device A 126 through SB master device i 128). A “slave” device may be characterized as a device which typically responses to requests received from other devices. A “master” device may be characterized as a device which typically initiates requests to other devices.

A non-limiting example of a slave device is a memory device or medium that responds to “read” commands and “write” commands from other devices. Thus, the memory unit is a “slave” device in that it is generally responding to instructions from a requesting master device.

A non-limiting example of a master device is a processing unit that initiates “read” commands and “write” commands to the above described memory device. Another example is an input/output (I/O) device that interfaces the system with external devices and/or other remote systems. Thus, the processor and the I/O device are “master” devices in that they provide instructions to a slave device.

Master devices and slave devices commonly access the shared bus 120 for convenience and efficiency. For example, if the SB master device A 122 needs access to SB slave device A 126, access is provided via connections 130/132 and the shared bus 120. If the SB master device A 122 needs access to SB slave device i 128, access is provided via connections 130/134 and the shared bus 120. Accordingly, SB master device A 122 may access a plurality of SB slave devices over the shared bus 120.

Similarly, if the SB master device M 124 needs access to SB slave device A 126, access is provided via connections 136/132 and the shared bus 120. If the SB master device M 124 needs access to SB slave device i 128, access is provided via connections 136/134 and the shared bus 120. Accordingly, SB master device A 122 may also access the same plurality of SB slave devices over the shared bus 120.

Access by the controlled devices (104, 106, 108, 110, 112, through 114) is provided to the master devices and/or to the slave devices coupled to the shared bus 120, via the interface master device 116 and connection 140, in the exemplary system of FIG. 1. Other embodiment systems may be configured differently such that data access is provided to the controlled devices over other connections and/or busses.

As a non-limiting example, interface master device 116 may be configured to receive communicated information (data or the like) from the above-described controlled devices (104, 106, 108, 110, 112, through 114). The controlled devices (104, 106, 108, 110, 112, through 114) may use data formats and/or bus protocols that are different from the data format and/or bus protocol used by the shared bus 120. Accordingly, the interface master device 116 may be configured to receive information from the controlled devices (104, 106, 108, 110, 112, through 114), and to process the received information into a data format and/or bus protocol used by the shared bus 120. Also, in this non-limiting example, the interface master device 116 is configured to receive information from the shared bus 120, and is configured to process the received information into a data format and/or bus protocol used by the controlled devices (104, 106, 108, 110, 112, through 114), and then communicate the information to the controlled devices (in the reverse direction). Other systems may employ another type of interface master device, or another type of commonly shared device, having a different functionality than the above-described interface master device 116. In such situations, the rewind arbiter 102 still controls access by the plurality of controlled devices as described herein.

For convenience of illustration, the controlled devices (104, 106, 108, 110, 112, through 114) are illustrated as coupled to the rewind arbiter 102 via a common connection 142. Common connection 142 is suitable in systems with addressable devices identified by unique identifiers. In other embodiments, the controlled devices (104, 106, 108, 110, 112, through 114) may be separately coupled to the rewind arbiter 102 with one or more individual connectors. Similarly, the rewind arbiter 102 is illustrated as coupled to the interface master device 116 via a common connection 144. Common connection 144 is suitable in systems with addressable devices identified by unique identifiers. In other embodiments, the controlled devices (104, 106, 108, 110, 112, through 114) may be each separately coupled to the rewind arbiter 102 and/or the interface master device 116 with one or more individual connectors.

As an illustrative example, if the controlled device A 104 requires access to SB slave device A 126, controlled device A 104 communicates a request for access to the system 118 to the rewind arbiter 102. The rewind arbiter 102 forwards this request by granting an arbitrated request, the arbitrated request corresponding to when it is the controlled device A's 104 turn to have access to the interface master device 116. When the interface master device 116 receives the arbitrated request (after arbitration by the rewind arbiter 102), access may be granted to the system 118 if the system is available, or may be granted access to system 118 when the system 118 becomes available to the interface master device 116 under an arbitration scheme implemented in the shared bus arbiter 146. Accordingly, access of the controlled device A 104 is provided to SB slave device A 126 via interface master device 116, connections 142/144/140/132, and the shared bus 120.

If the controlled device A 104 requires access to SB slave device i 128, similar to the exemplary scenario described above, controlled device A 104 communicates a request for access to the system 118 to the rewind arbiter 102. The rewind arbiter 102 communicates a corresponding arbitrated request when it is the controlled device A's 104 turn to have access to the interface master device 116. When the interface master device 116 receives the arbitrated request (after arbitration by the rewind arbiter 102), access is eventually granted to the system 118 when the system 118 is available. Accordingly, access of the controlled device A 104 is provided to SB slave device i 128 via interface master device 116, connections 142/144/140/134, and the shared bus 120.

Access by master devices to slave devices and/or other master devices, via the shared bus 120, may be controlled by another arbiter, as illustrated in FIG. 1 (shared bus arbiter 146). Shared bus arbiter 146 controls access of the plurality of master devices by selectively permitting only one of the master devices access to the shared bus 120 at a time. In the exemplary shared bus system 118, a master device communicates an access request to access the shared bus 120 to the shared bus arbiter 146, via its respective path 148. If the shared bus 120 is available (not being currently used by anther device), an access grant signal, arbitrated request, or the like, is returned to the requesting master device. The requesting master device then communicates onto the shared bus 120.

In the exemplary shared bus system 118, master devices and slave devices may be uniquely identified with an address. Thus, when a master device places a signal onto the shared bus 120, a portion of that signal contains the address of the intended recipient device. Upon recognizing its address, the intended recipient device appropriately responds in accordance with the signal communicated onto the shared bus 120 by the requesting master device.

On the other hand, if at the time that the master device communicates an access request to the shared bus arbiter 146 for access to the shared bus 120 when the shared bus 120 is not available (being currently used by anther device), an access grant signal, arbitrated request, or the like, is not returned to the requesting master device. The shared bus arbiter 146 withholds the access grant signal from the requesting master device until such time as the shared bus 120 is available (when the shared bus 120 is no longer being used by other devices).

There are many different types of shared bus arbiters 146 used by embodiments of the shared bus system 118. Such shared bus arbiters 146 employ a variety of arbitration schemes to avoid the “starvation” problem whereby a requesting master device is denied access to the shared bus 120 for an unreasonable length of time.

Similarly, embodiments of the rewind arbiter 102 selectively grant access of the controlled devices (104, 106, 108, 110, 112, through 114) to the interface master device 116 using any one of a variety of arbitration schemes. Arbitration is generally implemented by the arbitration scheme 150, the rewind scheme 152 and the verification scheme 154. The arbitration scheme 150, the rewind scheme 152 and the verification scheme 154 may each be implemented as logic using software, firmware, hardware or a combination of software, firmware and/or hardware, depending upon the particular embodiment of the rewind arbiter 102. Accordingly, various internal components of the rewind arbiter 102 are not illustrated or described in detail herein since the various embodiments are too numerous to practically describe, and because such specifics are not necessary to understand the novel features and operation of the rewind arbiter 102.

A non-limiting example of an arbitration scheme 150 determines (grants) access of the plurality of controlled devices in a serial fashion based upon a predefined access order. For example (presuming that all controlled devices concurrently need access to a commonly shared device), controlled device A. 104 may be granted access (through arbitration), followed by controlled device B 106, followed by controlled device C 108, followed by controlled device D 110, and so on. After controlled device N 114 (the last of the plurality of controlled devices) is granted access (corresponding to the rewind arbiter 102 communicating an arbitrated request downstream), the controlled device A 104 is next granted access. Thus, the process is repeated in serial fashion based upon the above-described predefined order of access.

Any desirable access order of the controlled devices may be predefined in alternative embodiments. For example, controlled device B 106 may be granted first access, next followed by controlled device A 104, then followed by controlled device C 108, and so on. Also, more than one access may be granted to a selected controlled device if a priority system is used. For example, controlled device A 104 may be given every other access grant by the rewind arbiter 102 (assuming that device A is an important device which requires frequent access to the interface master device 116). Thus, any suitable sequential order of the controlled devices may be employed by embodiments of the rewind arbiter system 100.

Embodiments of the rewind arbiter system 100 may be implemented using any type of arbitration scheme 150 whereby controlled access of the plurality of controlled devices (104, 106, 108, 110, 112, through 114) to the interface master device 116 is provided. Thus, the rewind arbiter 102 receives a request from a particular controlled device (104, 106, 108, 110, 112, through 114) and grants an arbitrated request providing access based upon the implemented arbitration scheme. The granted arbitrated request indicates to the controlled device that it is its turn, or that it has a turn in a queue, to access the commonly shared device or component.

After receiving a request from a controlled device (104, 106, 108, 110, 112, through 114) and communicating an arbitrated request downstream, a verification scheme 154 residing in the rewind arbiter 102 monitors the response of the controlled device to determine if the controlled device successfully communicated with the interface master device 116, hereinafter referred to as verifying. For any of a variety of reasons, the controlled device may not access the interface master device 116 in response to communicating its request to the rewind arbiter 102. If this failure to respond is repeated for a number of times by the controlled device, the controlled device is effectively “starved” from the interface master device 116. That is, the starved controlled device is unable to access the above-described interface master device 116, or access the SB master devices and/or the SB slave devices via the shared bus 120.

As described hereinbelow, the rewind arbiter 102 recognizes the starved condition and operates to grant an arbitrated request for access by the starved controlled device to commonly shared downstream devices. The verification scheme 154 is configured, in some embodiments, to differentiate between conditions where the controlled device is unable to successfully complete its communications at times when the controlled device was operable, and times when the controlled device is not accessing the interface master device 116 because of an inoperative condition or a failure condition.

In the event that the rewind arbiter 102 determines that one of the controlled devices has failed to successfully communicate with the interface master device 116 (verification of the request fails), the rewind scheme 152 operates. As described in greater detail below, the rewind scheme 152 causes the rewind arbiter 102 to grant additional arbitrated requests to the failed controlled device by rewinding the sequence of order in which requests from the plurality of controlled devices are arbitrated.

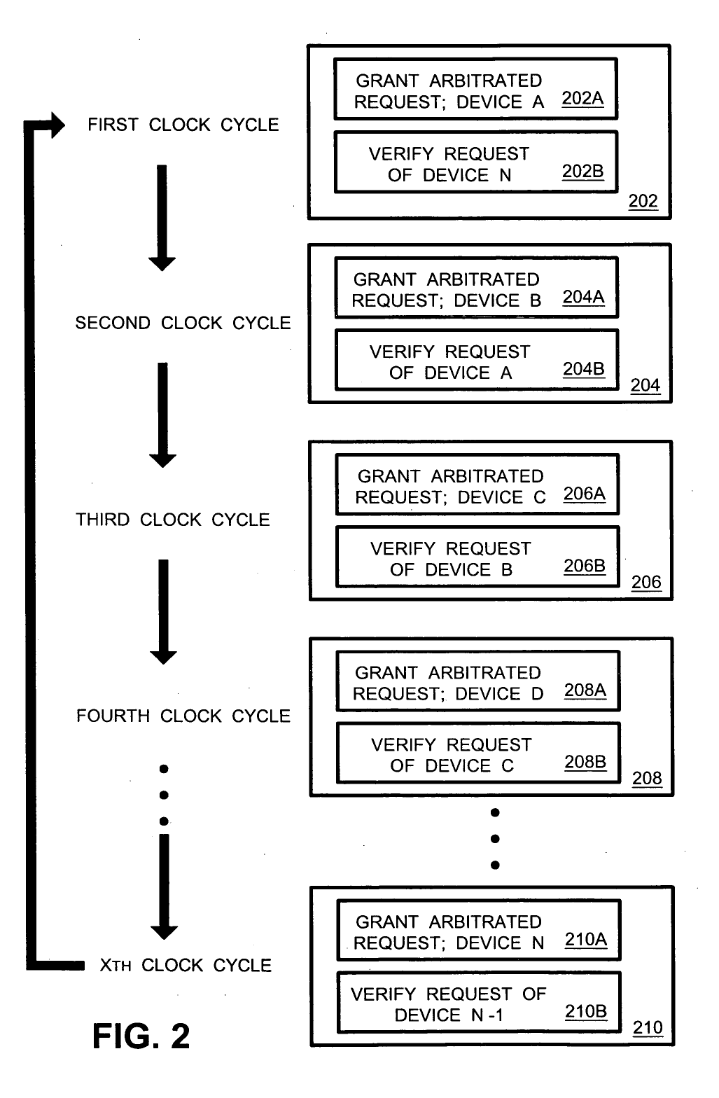

FIG. 2 is a block diagram illustrating operation of an embodiment of a rewind arbiter 102 (FIG. 1) operating when starvation of a controlled device is not occurring. This exemplary embodiment of a rewind arbiter 102 is described as performing two functions for each clock cycle or some period of time. In this example, a clock cycle is a discrete period of time wherein devices of the system perform their function (or multiple functions). Upon transition to the next clock cycle, the devices are signaled to perform a next function(s) during the next discrete period of time, if a function(s) is to be performed. Thus, in this exemplary embodiment, the rewind arbiter 102 performs a first function of allocating (granting an arbitrated request, and then communicating the arbitrated request to the interface master device 116) in response to a request received from a selected one of the controlled devices (104, 106, 108, 110, 112, through 114, illustrated in FIG. 1), and a second function of verifying that the controlled device successfully completed its communication with the interface master device 116 (FIG. 1). Verification is performed by the verification scheme 154 (FIG. 1). This process of cycling through granting and communicating arbitrated requests in response to a series of received requests, and verifying completion of communication by the previously requesting controlled device, is ongoing.

For convenience of describing an exemplary embodiment, the “first clock cycle” (corresponding to block 202) is selected to be that clock cycle wherein an arbitrated request is granted (corresponding to block 202A) to the controlled device A 104 (FIG. 1). Also, during the first clock cycle, the previous request of device N 114 is verified (corresponding to block 202B), wherein the term “verifying” means, for one embodiment, that the controlled device N 114 is checked to determine if it completed its communication with the interface master device 116. (The previously communicated request from controlled device N 114 is verified since it is the last of the predefined series of controlled devices, and since controlled device A 104 is the first in the predefined series of controlled devices.)

During the second clock cycle (corresponding to block 204), the rewind arbiter 102 grants an arbitrated request (corresponding to block 204A) in response to a request received from controlled device B 106 (FIG. 1) and verifies that the previous request of controlled device A 104 (received during the first clock cycle) was successfully completed (corresponding to block 204B).

Similarly, during the third clock cycle (corresponding to block 206), the rewind arbiter 102 grants an arbitrated request (corresponding to block 206A) in response to a request received from controlled device C 108 (FIG. 1) and verifies that the previous request of controlled device B 106 (received during the second clock cycle) was successfully completed (corresponding to block 206B).

Then, during the fourth clock cycle (corresponding to block 208), the rewind arbiter 102 grants an arbitrated request (corresponding to block 208A) in response to a request received from controlled device D 110 (FIG. 1) and verifies that the previous request of controlled device C 108 (received during the third clock cycle) was successfully completed (corresponding to block 208B).

The clock cycling continues until the Xth clock cycle is performed (corresponding to block 210), wherein the rewind arbiter 102 grants an arbitrated request (corresponding to block 210A) in response to a request received from controlled device N 114 (FIG. 1) and verifies that the previous request of controlled device N-1 (received during the previous clock cycle) was successfully completed (corresponding to block 210B). The process then restarts back to the above described first clock cycle (which would be referred, to as the eighth clock cycle in this simplified illustrative example).

For convenience, the above-described clock cycles were used to illustrate an embodiment of a rewind arbiter 102 that performed two functions during one clock cycle. Another embodiment of a rewind arbiter 102 may employ one clock cycle for each of the two functions. Other embodiments of a rewind arbiter 102 may include other functions that are performed during a current clock cycle and/or other clock cycles. Furthermore, the above-described clock cycles may be a system clock cycle as understood in the art, or may be a predefined period of time wherein the described functions are performed (depending upon the embodiment in which the rewind arbiter 102 is implemented in).

For convenience of describing embodiments of the rewind arbiter system 100, the arbitration scheme 150, rewind scheme 152 and the verification scheme 154 (FIG. 1) are described as discrete schemes. In other embodiments, the schemes 150, 152 and 154 may be integrated in various manners.

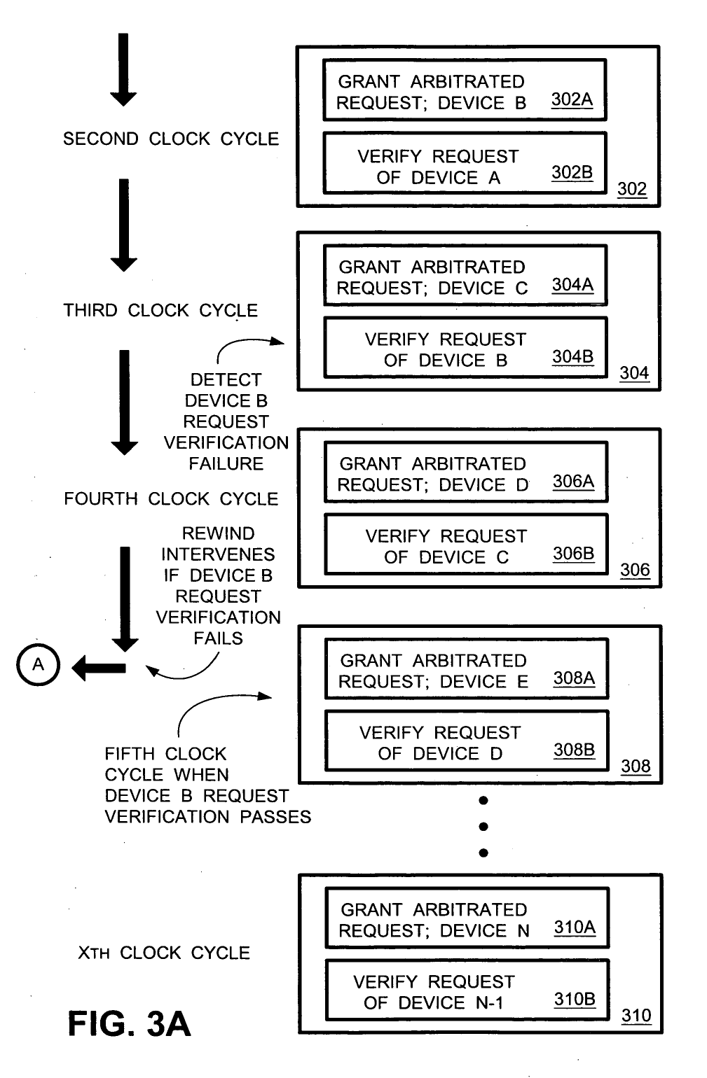

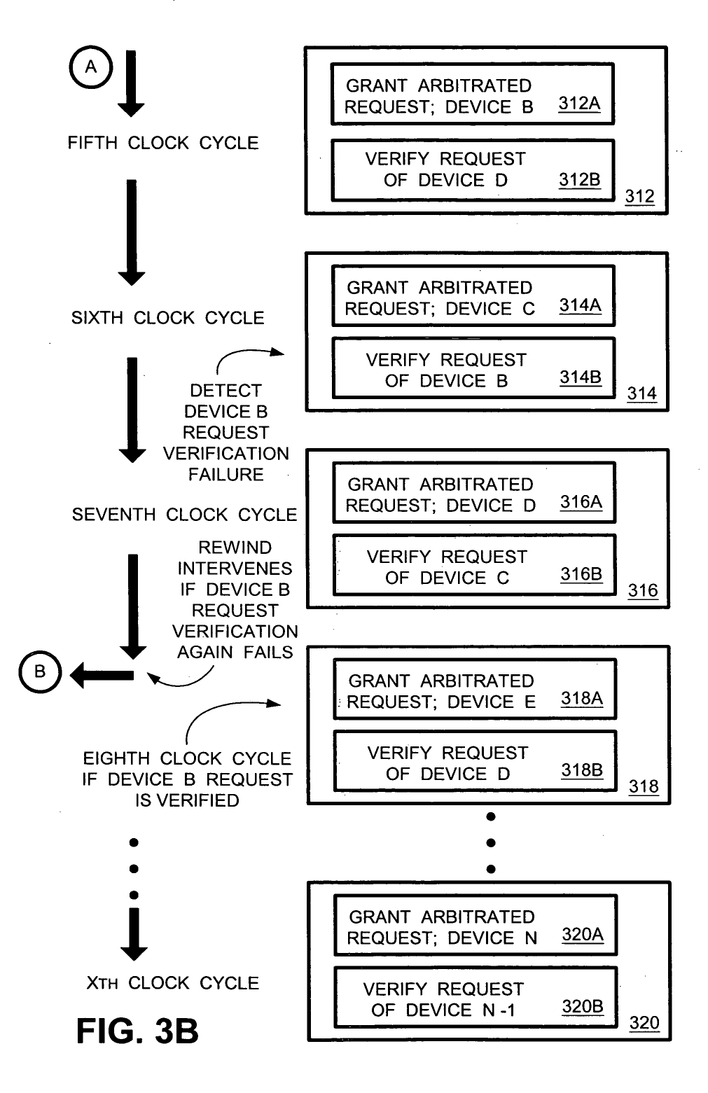

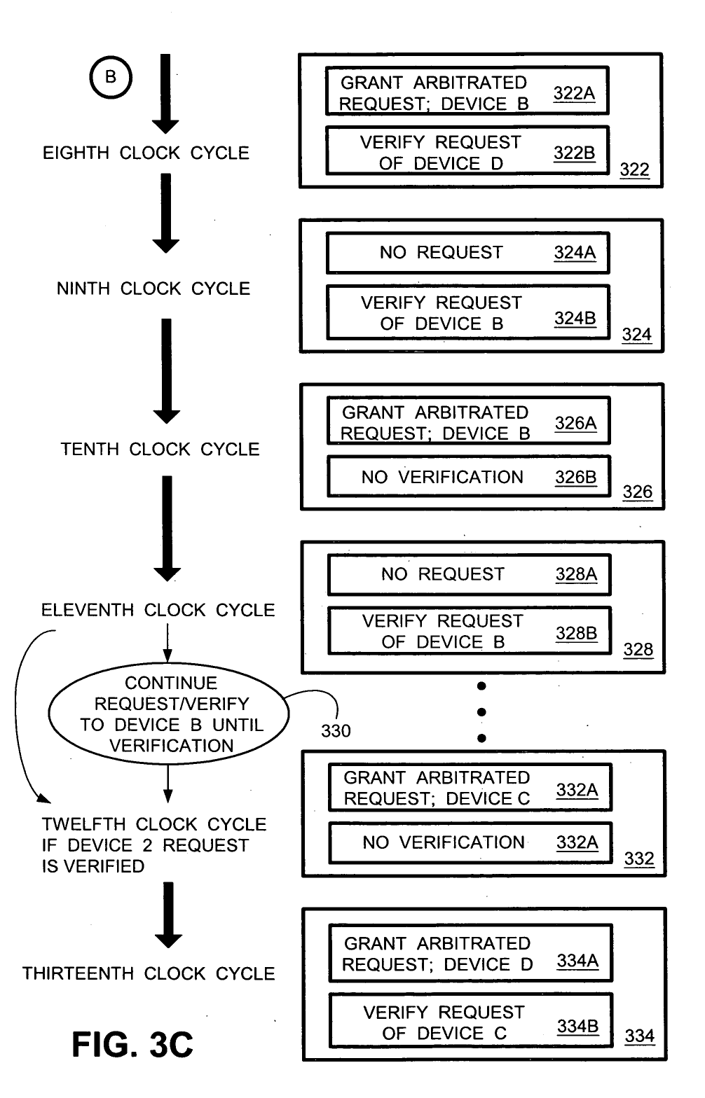

FIGS. 3A-C are block diagrams illustrating operation of an embodiment of a rewind arbiter 102 (FIG. 1) operating when starvation of one of the controlled devices is occurring. FIG. 3A presumes that the “first” clock cycle (wherein a request is granted to the controlled device A 104 and then communicated downstream as an arbitrated request, and wherein the previous request of controlled device N 114 is verified) has been completed.

During the second clock cycle (corresponding to block 302), an arbitrated request is granted in response to receiving a request from the controlled device B 106 (corresponding to block 302A) and the previous request of controlled device A 104 (FIG. 1) is verified (corresponding to block 302B). In this illustrative example, it is assumed that controlled device B 106 is unable to successfully complete communication with the interface master device 116.

During the third clock cycle (corresponding to block 304), an arbitrated request is granted in response to receiving a request from the controlled device C 108 (FIG. 1) (corresponding to block 304A) and the previous request of controlled device B 106 is verified (corresponding to block 304B). Since controlled device B 106 was unable to successfully complete communication to the interface master device 116, the verification fails.

At this point, the rewind scheme 152 (FIG. 1) will be activated during the next (fourth) clock cycle since the verification during the third clock cycle has failed.

During the fourth clock cycle (corresponding to block 306), an arbitrated request is granted in response to receiving a request from the controlled device D 110 (corresponding to block 306A) and the previous request of controlled device C 108 is successfully verified (corresponding to block 306B). Verification occurs since controlled device C 108 is able to complete its communication with the interface master device 116 in this simplified illustrative example.

This above-described process occurs during the fourth clock cycle since the rewind scheme 152 is actuated during the fourth clock cycle, and because the arbitration scheme logic 150 is still operating to arbitrate devices in the above-described predefined order. (In alternative embodiments, the arbitration scheme logic 150 may be disabled, or partially disabled, upon a determination of a verification failure during a preceding clock cycle such that the request is not communicated to the controlled device D 110 and/or the request sent to controlled device C 108 is not verified.)

During this fourth cycle, the rewind scheme 152 provides instructions to the rewind arbiter 102 that on the next clock cycle, the arbitration scheme 150 is to “rewind” back such that an arbitrated request is granted a second time to device B 106. Here, the term “rewind” (RW) denotes a backward resetting of the predefined order in which controlled devices are granted arbitrated requests for access to the interface master device 116 (via the request communicated from the rewind arbiter 102).

Accordingly, the block identified with reference numeral 308 is not performed by the rewind arbiter 102. Rather, during the fifth clock cycle, corresponding to block 312 (FIG. 3B), the rewind arbiter 102 causes rewinding to grant a second arbitrated request for the controlled device B 106 (corresponding to block 312A of FIG. 3B). Since during the previous clock cycle a request was completed by controlled device C, that communicated request is verified (corresponding to block of 312B of FIG. 3B).

This simplified example illustrates what happens when the rewind arbiter 102 detects the failure of controlled device B 106 such that the rewind process allows a starved controlled device B 106 to successfully complete its communication with the interface master device 116. Accordingly, the rewind scheme 152 causes a rewind back to controlled device B 106 such that a second out-of-turn arbitrated request is granted to controlled device B 106. Thus, the rewind scheme 152 causes a change in the current position of the predefined order of controlled devices such that a second out-of-turn arbitrated request is granted to controlled device B 106. That is, the rewind scheme 152 is configured to cause the arbitration scheme 150 to rewind back the predefined order to a controlled device that has failed to successfully complete communication with the master device (as determined by the verification scheme 154) such that the failed control device receives gets another arbitrated request.

In the above-described simplified example, three clock cycles were used for the rewind process (a first clock cycle to detect the failure of a controlled device to communicate, a second clock cycle for the rewind scheme 152 to determine and specify a rewind, and a third clock cycle to grant the second out-of-order arbitrated request). Other embodiments may be configured to use less than, or more than, the illustrative three clock cycles described hereinabove.

In one embodiment, the process of granting arbitrated requests and verifying continues as described hereinabove and as illustrated in FIG. 2 when the earlier failing controlled device successfully completes its communication with the interface master device 116. Accordingly, the process would continue to the Xth clock cycle (corresponding to block 310) such that the rewind arbiter 102 grants an arbitrated request (corresponding to block 310A) in response to receiving a request from the last controlled device N 114 (FIG. 1) and the previous request of controlled device N-1 is successfully verified (corresponding to block 310B). The process then starts over such that an arbitrated request is granted to controlled device A 104 and the previous request of controlled device N 114 is verified (see blocks 202, 202A and 202B of FIG. 2).

If, however, the earlier failing controlled device continues to fail in its communication with the interface master device 116, another rewind is implemented, as illustrated in FIG. 3B.

FIG. 3B illustrates the above-described fifth cycle associated with block 302 (FIG. 3A) after the first rewind process. That is, during the fifth clock cycle (corresponding to block 312 of FIG. 3B), a second arbitrated request is granted to the controlled device B 106 (corresponding to block 312A) and the previous request of controlled device D 110 is successfully verified (corresponding to block 3 12B).

During the sixth clock cycle (corresponding to block 314), an arbitrated request is granted in response to receiving a request from the controlled device C 108 (corresponding to block 314A) since controlled device C 108 is next in line in this simplified illustrative example. Also, the request associated with the second arbitrated request granted to controlled device B 106 is verified (corresponding to block 314B). Since controlled device B 106 was again unable to successfully complete communication to the interface master device 116 in this illustrative example, the verification during the sixth clock cycle has failed. At this point, the rewind scheme 152 will again be activated during the next (seventh) clock cycle since the verification during the sixth clock cycle has failed.

During the seventh clock cycle (corresponding to block 316), an arbitrated request is granted in response to receiving a request from the controlled device D 110 (corresponding to block 316A) and the previous request of controlled device C 108 is successfully verified (corresponding to block 316B). Verification occurs since controlled device C 108 is able to complete its communication with the interface master device 116 in this simplified illustrative example.

This above-described process occurs during the seventh clock cycle since the rewind scheme 152 is actuated during the seventh clock cycle, and because the arbitration scheme logic 150 is still operating to arbitrate devices in the above-described predefined order. (As described above, in alternative embodiments, the arbitration scheme logic 150 may be disabled, or partially disabled, upon a determination of a verification failure during a preceding clock cycle such that the request is not communicated to the controlled device D 110 and/or the request sent to controlled device C 108 is not verified.)

During this seventh clock cycle, the rewind scheme 152 provides instructions to the rewind arbiter 102 that on the next clock cycle, the arbitration scheme 150 is to “rewind” back such that an arbitrated request is granted a third time to device B 106. Accordingly, the eighth clock cycle, corresponding to the block 316, is not performed by the rewind arbiter 102. Rather, during the eighth cycle (corresponding to block 322, FIG. 3C), the rewind arbiter 102 grants a third arbitrated request to the controlled device B 106 (corresponding to block 322A, FIG. 3C). Since during the previous clock cycle an arbitrated request was granted to controlled device D, the associated request is verified (corresponding to parenthesis text of block 322B, FIG. 3C).

However, if during the sixth clock cycle, controlled device B successfully communicates with the interface master device 116, the process of communicating requests and verifying continues as described herein above and as illustrated in FIG. 2. That is, during the eighth cycle (corresponding to the block identified with reference numeral 318, FIG. 3B), the rewind arbiter 102 grants an arbitrated request to the controlled device E (corresponding to block 318A, FIG. 3B) and the previous request of controlled device D is verified (corresponding to block 318B, FIG. 3B).

Then, the process eventually continues to the Xth clock cycle (corresponding to block 320) such that the rewind arbiter 102 grants an arbitrated request (corresponding to block 320A, FIG. 3B) to last controlled device N 114 and the previous request of controlled device N-1 is successfully verified (corresponding to block 320B, FIG. 3B). The process then starts over such that arbitrated request is granted to controlled device A 104 and the previous request of controlled device N 114 is verified (see blocks 202, 202a and 202B of FIG. 2).

However, since in this simplified illustrative example controlled device B has again failed in its communication with the interface master device 116 (FIG. 1), as determined in the above-described sixth clock cycle, the rewind arbiter 102 continuously grants arbitrated requests to controlled device B, and then verifies, until the failing controlled device B completes its communication with the interface master device 116, as illustrated in FIG. 3C. That is, the rewind arbiter 102 suspends arbitrated requests from other controlled devices (104, 108, 110, 112, through 114), and maintains the arbitrated request for the controlled device B (which has previously twice failed to complete its communication with the interface master device 116).

Maintaining repeated grants to the failed controlled device B may be implemented in a variety of manners by various embodiments. For example, during the ninth clock cycle (corresponding to block 324 of FIG. 3), the rewind arbiter 102 does not grant arbitrated requests (corresponding to block 324A) to any controlled device. The previous request of controlled device B is verified (corresponding to block 324B). For the purposes of this simplified illustrative example, it is assumed that controlled device B is again unable to successfully complete communication to the interface master device 116. That is, the verification during the ninth clock cycle has failed. During the tenth clock cycle (corresponding to block 326), another arbitrated request is again granted to the controlled device B (corresponding to block 326A). There is no request to be verified (corresponding to block 326B).

Then, during the eleventh clock cycle (corresponding to block 328), the rewind arbiter 102 does not grant an arbitrated request (corresponding to block 328A) to any controlled device and the previous request from controlled device B during the tenth clock cycle is verified (corresponding to block 328B).

This process of granting an arbitrated request and verifying the request from controlled device B is continued (corresponding to block 330) until the rewind arbiter 102 has verified that the controlled device B 106 has successfully completed its communication with the interface master device 116. That is, the rewind arbiter 102 is configured to grant a plurality of further arbitrated requests to the failed control device, or maintain a current arbitrated request, depending upon the embodiment, until the verification scheme 154 verifies that the failed controlled device successfully completes communication with the interface master device. During this operation, granting arbitrated requests to the other controlled devices ceases. Accordingly, starvation of controlled device B 106 has been avoided.

Once the rewind arbiter 102 has verified that the controlled device B 106 has successfully completed its communication with the interface master device 116, the arbitration process continues. That is, if this example assumes that verification occurred during the eleventh clock cycle, then during the twelfth clock cycle (corresponding to block 332), an arbitrated request is granted to the controlled device C 108 (corresponding to block 332A). There is no request to be verified (corresponding to block 332B). Then, during the thirteenth clock cycle (corresponding to block 334), an arbitrated request is granted to the controlled device D 110 (corresponding to block 334A) and the previous request of controlled device C 108 during the twelfth clock cycle is verified (corresponding to block 334B). Accordingly, the normal arbitration process has resumed (previously described and illustrated in FIG. 2).

In another embodiment wherein repeated arbitrated request grants to a failed controlled device is not required (e.g.: the previous arbitrated request is maintained until verification), the blocks illustrated in FIG. 3C are reduced to a verification during each clock cycle. That is, the rewind arbiter 102 simply verifies at each clock cycle whether the controlled device has successfully completed its communication with the interface master device 116. Upon verification, the normal arbitration process resumes (previously described and illustrated in FIG. 2). Accordingly, starvation of a controlled device is avoided with this alternative embodiment.

The arbitration scheme 150, rewind scheme 152 and the verification scheme 154 may be implemented in any suitable arbitrator. Such arbitrators may use any type of arbitration scheme 150. The verification scheme 154 verifies that a controlled device, after being granted an arbitrated request for access to a shared component by the arbiter, successfully completes communication with the shared component. In the event that the controlled device fails to successfully complete access to the shared component, the rewind scheme 152 causes the arbiter to return to the previous sequence of arbitrated request grants and repeat the grant to the controlled device that failed to successfully complete access to the shared component.

Other embodiments of a rewind arbiter perform any suitable number of rewinds before granting continued arbitrated requests to (or maintaining the allocation of an arbitrated request) a starved controlled device. For convenience, the exemplary embodiment described above employed two rewinds. Another embodiment may, for example, employ three rewinds.

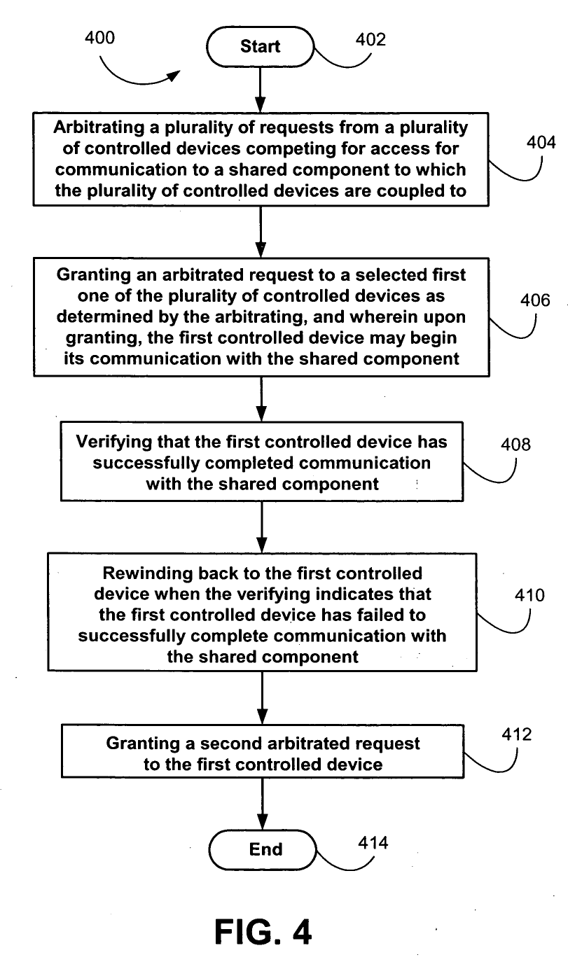

FIG. 4 shows a flow chart 400 illustrating a process for arbitrating device access. The flow chart 400 of FIG. 4 shows the architecture, functionality, and operation of an embodiment for implementing the logic of the arbitration scheme 150, the rewind scheme 152 and the verification scheme 154 (FIG. 1). An alternative embodiment implements the logic of flow chart 400 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIG. 4, or may include additional functions. For example, two blocks shown in succession in FIG. 4 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the disclosure.

The process begins at block 402. At block 404, arbitrating a plurality of requests from a plurality of controlled devices competing for access for communication to a shared component to which the plurality of controlled devices are coupled to is performed. At block 406, granting an arbitrated request to a selected first one of the plurality of controlled devices as determined by the arbitrating is performed, and wherein upon granting, the first controlled device may begin its communication with the shared component. At block 408, verifying that the first controlled device has successfully completed communication with the shared component is performed. At block 410, rewinding back to the first controlled device when the verifying indicates that the first controlled device has failed to successfully complete communication with the shared component is performed. At block 412, granting a second arbitrated request to the first controlled device is performed. The process ends at block 414.

Embodiments of the rewind arbiter system 100 (FIG. 1) residing in a memory as software may be stored using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

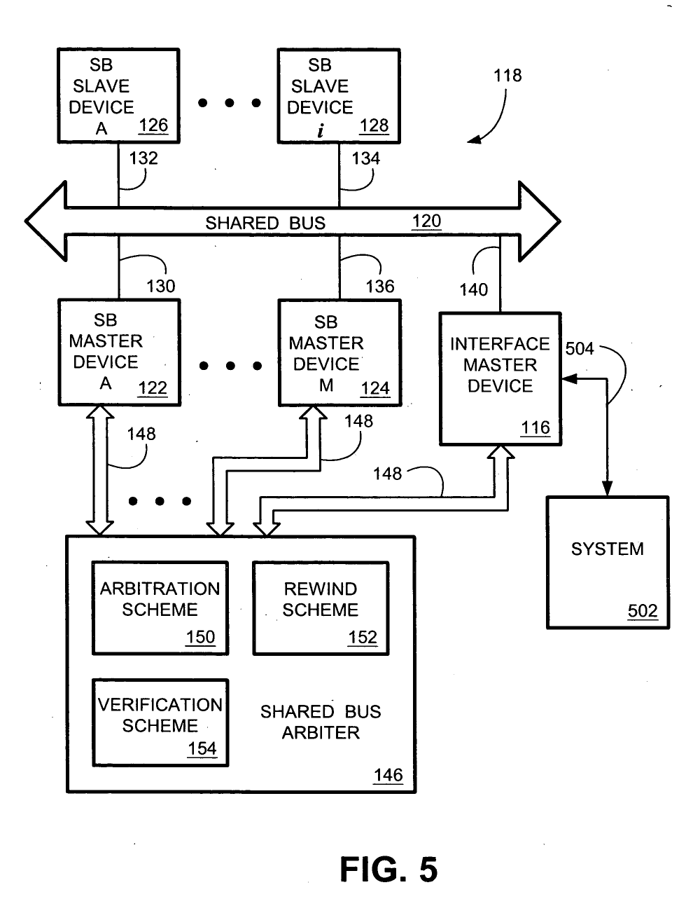

FIG. 5 is a block diagram illustrating another rewind arbiter system employing an embodiment of a rewind arbiter. As noted above, the rewind arbiter embodiment may be implemented in any suitable arbiter. To illustrate, the above-described arbitration scheme 150, rewind scheme 152 and verification scheme 154 are implemented in the above-described shared bus arbiter 146. Thus, this illustrated rewind arbiter embodiment alleviates device starvation events among the SB Master Device A 122 through SB Master Device M 124, and/or interface master device 116 (if present in the shared bus system 118) when such devices are accessing the shared bus 120.

Remote devices may also access shared bus 120 under the control of this exemplary embodiment. For example, the interface master device 116 may couple system 502, via connection 504, to the shared bus system 118. Remote devices (not shown) residing in system 502 may require access to the shared bus 120, via the interface master device 116. Thus, in the event that the interface master device 116 does not provide access to the requesting remote device residing in system 502, and/or if the requesting remote device does not access the shared bus 120, starvation may occur.

As described above, if one of the SB Master Device A 122 through SB Master Device M 124, interface master device 116 and/or remote device fails to complete its communications over the shared bus 120, the illustrated rewind arbiter embodiment causes the shared bus arbiter to rewind back to that device, as described hereinabove, such that the device is able to complete its communication over the shared bus 120. (It is noted that if the remote device residing in system 502 fails to complete its communications over the shared bus 120, the rewind is back to the interface master device 116 such that the remote device is able to complete its communications over the shared bus 120.)

It should be emphasized that the above-described embodiments are merely examples of the disclosed system and method. Many variations and modifications may be made to the above-described embodiments. All such modifications and variations are intended to be included herein within the scope of this disclosure.

What is claimed is:

1. An arbitration system, comprising:
a plurality of controlled devices configured to access a shared component; and
a rewind arbiter configured to arbitrate among a plurality of requests received from the controlled devices, wherein one of the controlled devices communicating a request that is selected during arbitration is then granted access to the shared component, the rewind arbiter further comprising:
an arbitration scheme configured to grant arbitrated requests to the controlled devices;
a verification scheme configured to verify that the controlled devices successfully complete communication with the shared component; and
a rewind scheme configured to cause the arbitration scheme to rewind back to a controlled device that has failed to successfully complete communication with the shared component such that the failed control device is granted a second arbitrated request.

2. The arbitration system of claim 1, wherein the rewind arbiter sequentially grants the arbitrated requests to the controlled devices in a predefined order and wherein the arbitration scheme rewinds back the predefined order to the controlled device that has failed to successfully complete communication with the shared component such that the failed control device is granted the second arbitrated request.

3. The arbitration system of claim 1, wherein the rewind arbiter is further configured to grant the second arbitrated request to the shared component.

4. The arbitration system of claim 1, wherein the verification scheme is further configured to verify that the failed controlled device successfully completes communication with the shared component in response to receiving the second arbitrated request.

5. The arbitration system of claim 4, wherein the rewind scheme is further configured to cause the arbitration scheme to again rewind back to the failed controlled device if it again fails to successfully complete communication with the shared component.

6. The arbitration system of claim 5, wherein the rewind arbiter is further configured to grant a series of further arbitrated requests to the failed control device until the verification scheme verifies that the failed controlled device successfully completes communication with the shared component.

7. The arbitration system of claim 1, wherein the shared component is an interface device.

8. The arbitration system of claim 1, wherein the shared component is commonly shared by the plurality of controlled devices and wherein the plurality of controlled devices compete for access to the shared component because the shared component is configured to communicate with only one of the controlled devices at a time.

9. The arbitration system of claim 1, wherein the shared component is a shared bus.

10. The arbitration system of claim 1, wherein the shared component competes with other devices for access to a shared bus, and wherein access of the shared component to the shared bus is controlled by another arbiter.

11. A method for arbitrating device access, the method comprising:
arbitrating a plurality of requests from a plurality of controlled devices competing for access for communication to a shared component to which the plurality of controlled devices are coupled to;
granting an arbitrated request to a selected first one of the plurality of controlled devices as determined by the arbitrating, and wherein upon granting, the first controlled device may begin its communication with the shared component;
verifying that the first controlled device has successfully completed communication with the shared component;
rewinding back to the first controlled device when the verifying indicates that the first controlled device has failed to successfully complete communication with the shared component; and
granting a second arbitrated request to the first controlled device.

12. The method of claim 11, wherein the arbitrating further comprises determining a sequential order for the plurality of controlled devices competing for access for communication to the shared component and wherein the granting is based upon a determined predefined order.

13. The method of claim 11, further comprising granting a subsequent arbitrated request to a next controlled device that is selected during the arbitrating after the granting of the arbitrated request to the selected first controlled device.

14. The method of claim 11, further comprising verifying that the next controlled device has successfully completed communication with the shared component.

15. The method of claim 11, further comprising providing access to the selected first controlled device to communicate with the shared component in response to granting the arbitrated request.

16. The method of claim 11, further comprising verifying that the first controlled device has successfully completed communication with the shared component in response to granting the second arbitrated request.

17. The method of claim 16, further comprising:
rewinding a sequential order back to the first controlled device when the verifying indicates that the first controlled device has failed to successfully complete communication with the shared component; and
granting a third arbitrated request to the first controlled device.

18. The method of claim 17, further comprising verifying that the first controlled device has successfully completed communication with the shared component in response to the granted third arbitrated request.

19. The method of claim 16, further comprising:
rewinding back to the first controlled device when the verifying indicates that the first controlled device has failed to successfully complete communication with the shared component in response to the second arbitrated request; and
granting a plurality of further arbitrated requests to the first controlled device until the first controlled device has successfully completed communication with the shared component.

20. The method of claim 16, further comprising ceasing granting of other arbitrated requests to the non-selected controlled devices.

21. The method of claim 11, wherein the shared component is a shared bus.

22. A system for arbitrating device access, comprising:
means for determining a sequential order for a plurality of controlled devices competing for access for communication to a commonly shared device to which the plurality of controlled devices are coupled to;
means for granting an arbitrated request to a selected first one of the plurality of controlled devices, wherein upon granting, the first controlled device begins its communication with the commonly shared device;
means for verifying that the first controlled device has successfully completed communication with the commonly shared device;
means for rewinding the sequential order back to the first controlled device when the verifying indicates that the first controlled device has failed to successfully complete communication with the commonly shared device; and
means for granting a second arbitrated request to the first controlled device.

23. The system of claim 22, wherein the means for verifying further verifies that the first controlled device has successfully completed communication with the commonly shared device in response to granting the second arbitrated request.

24. The system of claim 23, wherein the means for rewinding further rewinds the sequential order back to the first controlled device when the verifying indicates that the first controlled device has failed to successfully complete communication with the commonly shared device in response to granting the second arbitrated request, and wherein the means for granting further grants a third arbitrated request to the first controlled device.

25. The system of claim 24, wherein the means for verifying further verifies that the first controlled device has successfully completed communication with the commonly shared device in response to granting the third arbitrated request.

26. The system of claim 24, wherein the means for rewinding rewinds the sequential order back to the first controlled device when the verifying indicates that the first controlled device has failed to successfully complete communication with the commonly shared device in response to granting the second arbitrated request, and wherein the means for granting further grants a plurality of further arbitrated requests to the first controlled device until the first controlled device has successfully completed communication with the commonly shared device.

27. A program for arbitrating device access stored on a computer-readable medium, the program comprising:
logic configured to determine an order for a plurality of controlled devices competing for access for communication to a master device to which the plurality of controlled devices are coupled to;
logic configured to grant an arbitrated request to a selected first one of the plurality of controlled devices, wherein upon granting the first controlled device begins its communication with the master device;
logic configured to verify that the first controlled device has successfully completed communication with the master device;
logic configured to rewind the order back to the first controlled device when the verifying indicates that the first controlled device has failed to successfully complete communication with the master device; and
logic configured to grant a second arbitrated request to the first controlled device.
